(19) United States
(12) Patent Application Publication
(10) Pub. No.: US 2005/0280745 A1
(43) Pub. Date: Dec. 22, 2005

(54) Video display apparatus

(75) Inventors: Kazuyuki Takeda, Ora-gun (JP); Osamu Sato, Kumagaya-shi (JP); Kohei Watanabe, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/144,784

(22) Filed: Jun. 6, 2005

(30) Foreign Application Priority Data
Jun. 17, 2004 (JP) 2004-179677

(51) Int. Cl. H04N 5/52; G02F 1/00

(52) U.S. Cl. 348/771; 348/687; 348/679

(57) ABSTRACT

A display apparatus of the present invention has an optical engine (image generating unit) which has a light source, a digital micro mirror device (DMD) panel, and a color wheel having a white segment, the image generating unit projecting a white image and video lights of each color at certain time intervals, and a panel driver which outputs signals B, G and R to the DMD panel, wherein a brightness compensating circuit which performs nonlinear conversion for a brightness signal component (Y) according to the level of brightness component, to control a high brightness level portion of the brightness signal component, and a color compensating circuit which performs nonlinear conversion for two color difference signal components (Cb/Cr), to increase saturation.

### CROSS-REFERENCE TO RELATED APPLICATIONS

This application is based upon and claims the benefit of priority from prior Japanese Patent Application No. 2004-179677, filed Jun. 17, 2004, the entire contents of which are incorporated herein by reference.

### BACKGROUND OF THE INVENTION

1. Field of the Invention

The present invention relates to an image display apparatus applicable to a digital light processing (DLP) color projector.

2. Description of the Related Art

In a DLP color projector, light emitted from a white light source advances through blue (B), green (G) and red (R) segments provided in a color wheel, and enters into a digital micro mirror device (DMD). The DMD panel has many micro mirrors, which selectively reflect B, G and R lights given at certain time intervals, that is, the lights transmitted through segments B, G and R, and generate optical images B, G and R. In this time, the optical images B, G and R are turned (projected) to a predetermined direction. The projected image lights (optical images) B, G, and R are magnified with a magnifying lens system, and projected on a screen.

The related arts are disclosed in Jpn. Pat. Appln. KOKAI Publication Nos. 2001-188196 and 2000-231079.

In a certain color projector, a white (W) segment is provided in a color wheel in addition to B, G and R segments, in order to increase brightness of image. Namely, four lights B, G, R and W are given at certain time intervals as lights applied to a DMD panel. Of course, when a W-light is applied, a white image is reflected from each mirror of DMD.

When brightness is increased by using a white segment, an image becomes bright in a portion where the color is pale. However, in a projected image of a scene (image) having a subject colored with a white background, a colored portion seems (feels) dark. In this case, vividness of color may feels lost by the influence of white. The dark feeling of a colored portion dark is dependent on the nature of human eyes, and caused by recognition of the color of a colored subject compared with a white background.

### BRIEF SUMMARY OF THE INVENTION

According to an aspect of the present invention, there is provided a video display apparatus comprising:
an optical engine (video display unit) which has a light source, a digital micro mirror device (DMD) panel including mirrors disposed like a matrix, the mirrors turned independently to a predetermined direction, and a color wheel having a white segment, the video display unit projecting a white image and video lights of each color at certain time intervals;
a panel driver which controls directions of micro mirrors on the digital micro mirror device panel, and outputs signals B, G and R suitable for driving the micro mirrors, toward a direction controlled mirror at a predetermined timing;
a brightness compensating circuit which performs nonlinear conversion for a brightness signal component included in an input video signal, to control a high brightness level portion of the brightness signal component;
a color compensating circuit which performs nonlinear conversion for two color difference signal components included in an input video signal, to increase saturation; and
a conversion circuit which converts outputs of the brightness compensating circuit and color compensating circuit into signals B, G and R, and supplies them to the panel driver.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing an example of an embodiment of a projector according to the present invention;

FIG. 2 is a graph explaining input-output characteristics in a brightness compensating circuit and a color compensating circuit incorporated in the projector shown in FIG. 1;

FIG. 3 is a schematic illustration showing an example of basic configuration of a video display unit (an optical engine) applicable to the projector shown in FIG. 1; and

FIG. 4 is a schematic diagram explaining an example of a brightness compensating circuit and a color compensating circuit incorporated in the projector shown in FIG. 1.

### DETAILED DESCRIPTION OF THE INVENTION

Hereinafter preferred embodiments of the present invention will be explained in detail with reference to the accompanying drawings.

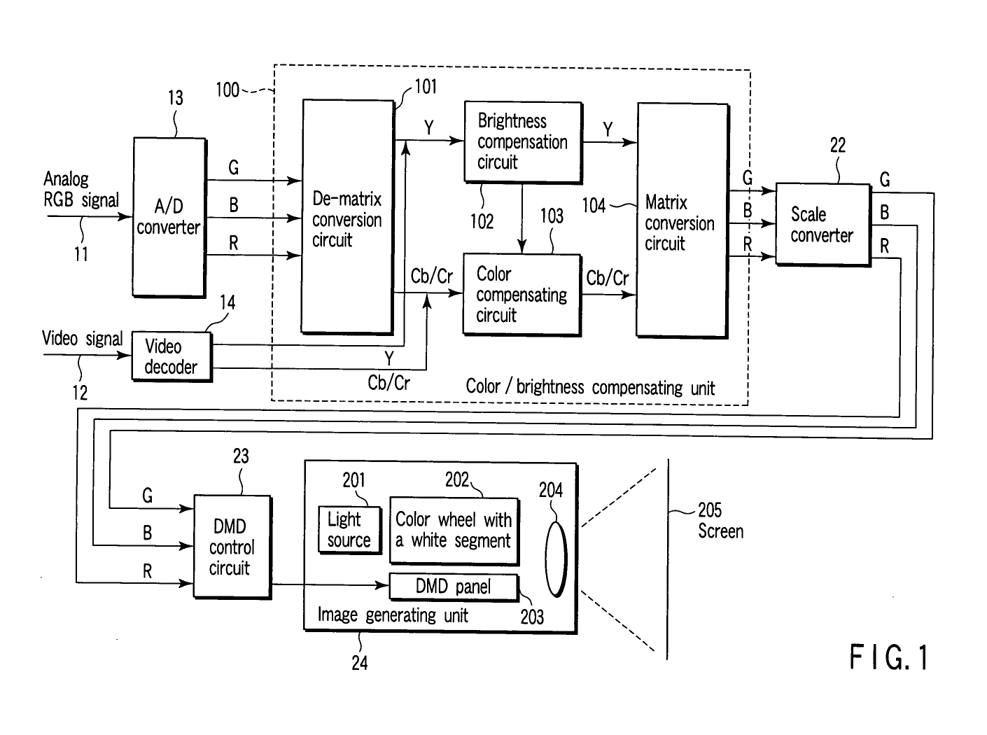

FIG. 1 shows an example of a digital light processing (DLP) color projector of according to the present invention.

Analog signals B, G and R are given to an input unit 11, and guided to an analog-digital (A/D) converter 13. A video signal is given to an input unit 12, and guided to a video decoder 14.

The signals B, G and R converted into digital signals in the A/D converter 13 are given to a de-matrix conversion circuit 101 of a color/brightness compensating unit 100, which is an essential part of the present invention.

The signals B, G and R (digital) given to the de-matrix conversion circuit 101 are converted into a brightness (Y) signal, a color difference signal (Cb/Cr signal, digital, also simply called “C”). The Y-signal generated in the de-matrix conversion circuit 101 is supplied to a brightness compensating circuit 102, and the C-signal is supplied to a color compensating circuit 103.

Digital signals Y and C can also be obtained in the video decoder 14. The signals Y and C from the decoder 14 are also supplied to the brightness compensating circuit 102 and color compensating circuit 103, respectively. The signals Y and C of one channel are given to the brightness compensating circuit 102 and color compensating circuit 103, through a selector of a not-shown input unit.

In the brightness compensating circuit 102, the Y-signal is converted nonlinearly according to the brightness. Namely, in the brightness compensating circuit 102, nonlinear conversion is made for a brightness signal component of an input video signal, to control the high brightness side according to the brightness component level (to control a high brightness level portion of the brightness signal component included in the input video signal). One nonlinear processing is to control a white peak of a brightness signal component. The other nonlinear processing is to lighten a middle range of a brightness signal component (to increase the brightness of the middle range of a brightness signal component).

The color compensating circuit 103 increases saturation of two color difference signal components (Cb/Cr) in a specific brightness area of an input video signal. Namely, the color compensating circuit 103 performs nonlinear processing to increase saturation for two color difference signal components with high brightness.

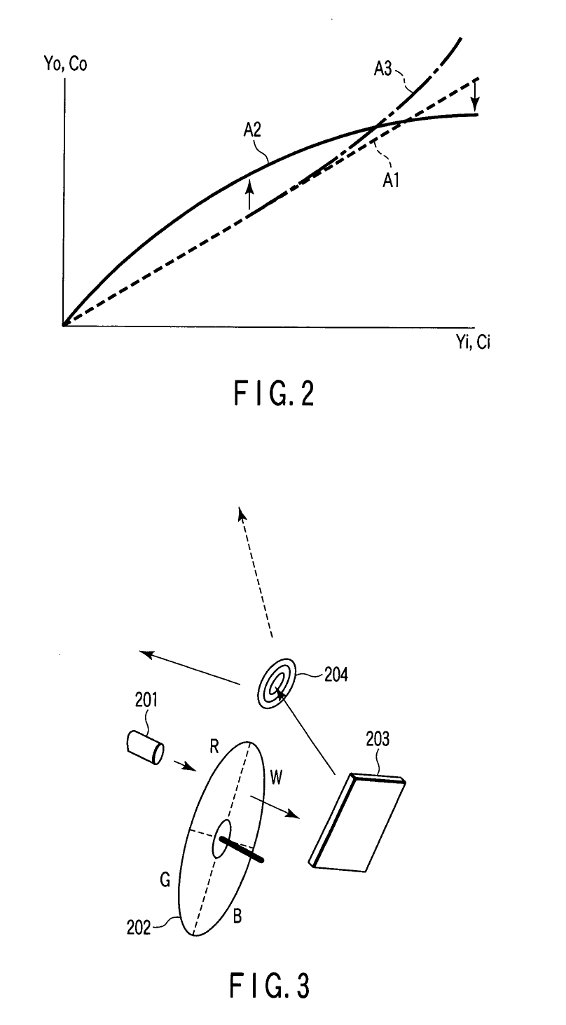

FIG. 2 shows the input-output characteristics of the above nonlinear processing. The horizontal axis indicates an input (Yi, Ci), and the vertical axis indicates an output (Yo, Co).

In FIG. 2, the characteristic line A1 (a dotted line=a straight line) indicates the case where nonlinear conversion is not performed. The characteristic line A2 (a solid line) indicates the conversion characteristics for the Y-signal. The characteristic line A3 (a chain line) indicates the conversion characteristic for the C-signal.

As seen from FIG. 2, a nonlinear characteristic to control a white peak and lighten a middle range is applied to the Y-signal, and a nonlinear characteristic to increase saturation for a signal component belonging to a high brightness area is applied to the C-signal.

Referring again to FIG. 1, the signals Y and C after the nonlinear conversion shown in FIG. 2 are sent to the matrix conversion circuit 104, and converted (returned to) into the signals B, G and R (in the matrix conversion circuit 104).

The nonlinearly converted and returned to the signals B, G and R are sent to a scale converter 22 (an input stage of a DMD panel driver). A DMD circuit driver includes at least a scale converter 22 and a DMD control circuit 23 provided in a later stage.

The scale converter 22 is used to obtain pixel signals B, G and R corresponding to the resolution (the number of pixels) of a DMD panel 203, and matches the resolution of the input signals B, G and R to that of the DMD panel 203. Namely, the scale converter 22 adjusts the number of pixels of the input signals B, G and R to the number of micro mirrors (the total number of mirrors) of the DMD panel 203.

The video signals B, G and R from the scale converter 22 are applied to the DMD control circuit 23 in a later stage.

The DMD control circuit 23 generates a W (white) pixel signal from the input pixel signals B, G and R. The DMD control circuit 23 may generate a W-pixel signal for a certain period (hour) on the whole screen as a simple signal corresponding to a white segment.

The B, G, R and W pixel signals from the DMD control circuit 23 are supplied in time division to the DMD panel 203 of am image generating unit (optical engine) 24 at certain time intervals.

The image generating unit 24 includes a DMD panel 203, light source 201, color wheel 202 with a white segment, and lens 204.

FIG. 3 shows the basic elements and operation of the image generating unit 24.

Light from the light source 201 is transmitted through a specific color area of the color wheel 202, in which predetermined segments are positioned (at that timing) corresponding to an image signal divided at certain time intervals, and applied to each micro mirror surface of the DMD panel. The color wheel 202 has segments of B, G, R and W.

The DMD panel 203 changes the reflecting direction of each micro mirror to a predetermined direction at certain time intervals (in units of display image for each color) based on the pixel signals B, G, R and W. Namely, the pixel lights B, G, R and W of display unit for each color are reflected in a direction corresponding to a direction of each mirror. Thus, the pixel light B, G, R and W for each color are continuously emitted to the magnifier 204. A magnified color image emitted from the lens 204 is projected on the screen 205.

On the rotary axis of the color wheel 202, a not-shown drive motor of a predetermined speed (rpm) is provided. Therefore, the wheel is driven (at a predetermined speed), so that the segments for the pixel signals B, G, R and W are turned to the DMD panel 203 at certain time intervals in synchronization with the driving of the DMD panel 203 corresponding to the signals B, G, R and W.

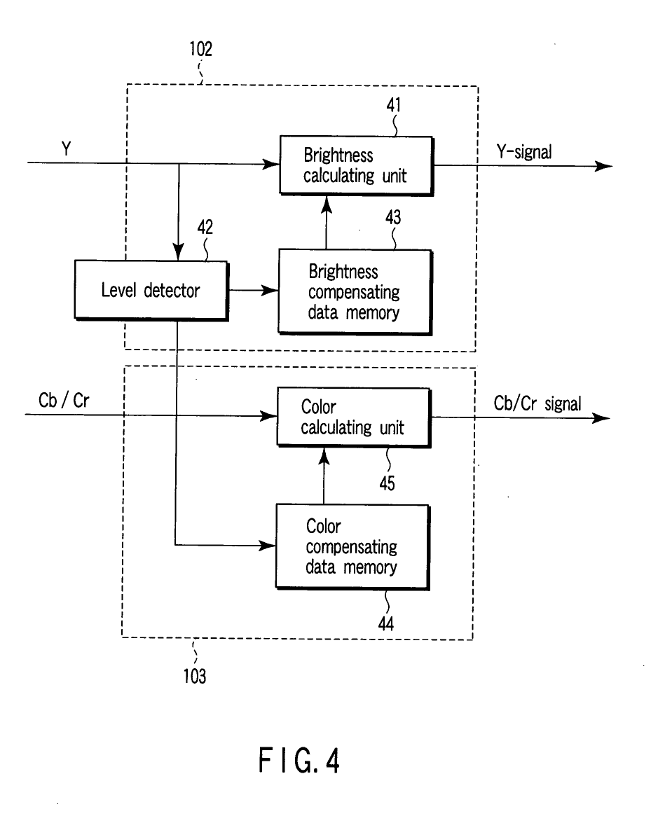

FIG. 4 shows the details of the brightness compensating circuit 102 and color compensating circuit 103.

As shown in FIG. 4, the Y-signal is applied to a brightness computing unit 41 and a level detector 42.

The level detector 42 detects the position (level) of the Y-signal on the horizontal axis shown in FIG. 2. The information detected with the level detector 42 is given to a brightness compensating data memory 43. The brightness compensating data memory 43 outputs a coefficient to compensate the Y-signal according to the level, and gives it to the brightness computing unit 41.

In the brightness computing unit, the coefficient is multiplied, added or subtracted by/to/from the Y-signal. Thus, the brightness compensating circuit provides an output according to the characteristic line A2 in FIG. 2.

The information from the level detector 42 is given also to a color compensating data memory 44 of the color compensating circuit 103. The color compensating data memory 44 outputs a coefficient to compensate the C-signal according to the brightness level, and gives it to a color computing unit 45. Thus, the color compensating circuit 103 provides an output according to the characteristic line A3 in FIG. 2.

In FIG. 4, the color/brightness compensating unit 100 is shown as if it is configured with hardware. However, the essential characteristics of the present invention are not limited to the hardware configuration. It is also possible to realize data processing functions of each block in the color/brightness compensating unit 100 based on software. Namely, the color/brightness compensating unit 100 can be achieved also by a digital processor.

The color/brightness compensating unit 100 is not limited to the embodiment described hereinbefore. For example, an adjustment device may be added to make fine adjustment of compensated data. It is effective to adjust the detection sensitivity of the level detector 42, instead of using an adjustment device.

According to the present invention, a brightness signal component is controlled in a high brightness portion, and a color component is increased in saturation. As a white component is increased, darkness of a colored portion (a chromatic color) is decreased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A video display apparatus comprising:
an image generating unit which has a light source, a digital micro mirror device (DMD) panel including mirrors disposed like a matrix, the mirrors turned independently to a predetermined direction, and a color wheel having a white segment, the image generating unit projecting a white image and video lights of each color at certain time intervals;
a panel driver which controls directions of micro mirrors on the digital micro mirror device panel, and outputs signals B, G and R suitable for driving the micro mirrors, toward the direction controlled mirror at a predetermined timing;
a brightness compensating circuit which performs nonlinear conversion for a brightness signal component included in an input video signal, to control a high brightness level portion of the brightness signal component;
a color compensating circuit which performs nonlinear conversion for two color difference signal components included in an input video signal, to increase saturation; and
a conversion circuit which converts outputs of the brightness compensating circuit and color compensating circuit into signals B, G and R, and supplies them to the panel driver.

2. The video display apparatus according to claim 1, wherein the nonlinear processing in the brightness compensating circuit is to control a white peak of a brightness signal component.

3. The video display apparatus according to claim 2, wherein the nonlinear processing in the brightness compensating circuit is to increase the brightness of a middle range of a brightness signal component.

4. The video display apparatus according to claim 2, wherein the nonlinear processing in the color compensating circuit is applied to a color difference signal component in a high brightness area.

5. The video display apparatus according to claim 1, wherein the brightness compensating circuit comprising:
a level detector which detects a level of an input brightness signal;
a brightness compensating data memory which outputs a coefficient based on the information from the level detector; and
a brightness calculating unit which calculates the coefficient and input brightness signal, and
the color compensating circuit comprising:
a color compensating data memory which outputs a coefficient based on the information from the level detector; and
a color calculating unit which calculates the coefficient from the memory and an input color signal.
